(19) United States
(12) Patent Application Publication
(10) Pub. No.: US 2007/0047959 A1
(43) Pub. Date: Mar. 1, 2007

(54) SYSTEM AND METHOD FOR SUPPORTING COMMUNICATIONS BETWEEN SUBCRIBER OPTICAL INTERFACES COUPLED TO THE SAME LASER TRANSCEIVER NODE IN AN OPTICAL NETWORK

(75) Inventors: Stephen A. Thomas, Marietta, GA (US); Kevin L. Bourg, Alpharetta, GA (US)

Correspondence Address: KING & SPALDING LLP, 1180 PEACHTREE STREET, ATLANTA, GA, 30309-3521, US

(73) Assignee: Wave7 Optics, Inc., Alpharetta, GA (US)

(21) Appl. No.: 11/464,486

(22) Filed: Aug. 14, 2006

Related U.S. Application Data
(60) Provisional application No. 60/707,790, filed on Aug. 12, 2005.

(51) Int. Cl. H04J 14/00

(52) U.S. Cl. 398/72

(57) ABSTRACT

A backwards compatible method and system for receiving upstream frames and reflecting the frames downstream to support communications between subscriber optical interfaces (SOIs) coupled to a same laser transceiver node (LTN) are explained. Backwards compatible means that the method or system is compatible with legacy subscriber optical interfaces that do not need any new or modified hardware. The backwards compatible method assigns each legacy SOI a set of Port-IDs to support communications with SOIs on the same optical network. In addition to a backwards compatible method and system, a non-backwards compatible system or method that are not compatible with legacy subscriber optical interfaces 140 is described. According to this method and system, each LTN and SOI would need additional new hardware or software (or both) to support new fields of an optical network protocol that indicate multicast downstream frames originating from another SOI.

### STATEMENT REGARDING RELATED APPLICATIONS

The present application claims priority to provisional patent application entitled, “Forwarding between ONUs on G.984 passive optical networks,” filed on Aug. 12, 2005 and assigned U.S. Application Ser. No. 60/707,790, the entire contents of which are hereby incorporated by reference.

### TECHNICAL FIELD

The invention relates to communications over an optical network. More particularly, the invention relates to additions and improvements to an optical network protocol that can support communications between subscriber optical interfaces that are coupled to the same laser transceiver node in an optical network.

### BACKGROUND OF THE INVENTION

Conventional optical networks can provide communications between subscribers who are coupled to the optical network. These conventional optical networks can use different types of protocols to support these communications. One protocol that is currently used is the International Telecommunications Union (ITU)—G.984—Gigabit capable Passive Optical Network (GPON) protocol. The GPON protocol can support various types of communications between subscribers over an optical network.

While the GPON protocol is a robust protocol for supporting communications, it currently has several drawbacks that make the protocol inefficient. One such drawback exists for subscribers who are coupled to the same laser transceiver node (LTN) within the same optical network. A laser transceiver node (LTN), also referred to in the industry as an optical line terminal (OLT), is a communications link between subscribers and a data service hub. A data service hub is typically referred to in the industry as a head end or Central Office.

The laser transceiver node (LTN) can apportion bandwidth for each of the subscribers that it supports and it is usually responsible for routing communications received from the data service hub to the subscriber and vice-versa. Further details of a LTN and data service hub are described in U.S. Pat. No. 6,973,271, entitled, “System and Method for Communicating Optical Signals between a Data Service Provider and Subscribers”, the entire contents of which are hereby incorporated by reference. Subscribers are coupled to the laser transceiver node usually with a subscriber optical interface (SOI), also referred to in the industry as an optical network unit (ONU).

The drawback mentioned above for the GPON protocol exists for subscribers who are coupled to the same laser transceiver node within the same optical network. The drawback can be demonstrated with a simple example: a telephone call between neighbors in which each SOI is coupled to the same LTN. Specifically, this exemplary application can have several characteristics, all of which are desirable in many deployments: (1) Telephone service is implemented with Voice over Internet Protocol (VOIP) media gateways in each SOI. The gateways can be embedded within each SOI so that subscribers are able to use traditional analog handsets. (2) The IP host addresses for both media gateways within the SOIs can reside in a common IP subnetwork. Forcing the SOIs to reside on different IP subnetworks can significantly and inefficiently consume IP address space. (3) The media stream (using the Real Time Protocol over the User Datagram Protocol) carrying a subscriber's conversations must begin and end at the SOIs. (Note that the media stream is usually completely separate from the call signaling exchange between the SOIs and a voice softswitch; call signaling protocols such as the Session Initiation Protocol or H.248 is not relevant for this example.) Referring now to FIG. 1, this figure illustrates several SOIs 140 coupled to the same LTN 120 through an optical tap which is usually a passive optical splitter known to one of ordinary skill in the art. The SOIs 140 are coupled to the LTN 120 with optical waveguides 150 that form a first optical network 200A. The LTN 120 is coupled to a data service hub 110 with an optical waveguide 150. Second and third optical networks 200B and 200C can be coupled to the data service hub 110. This figure also illustrates the communication traffic flow under consideration. In this example, a subscriber connected to a first SOI 140A is conversing with a subscriber connected to a third SOI 140C. The LTN 120 in this conventional example cannot simply forward frames “upstream” and usually expects an upstream switch to reflect them back downstream. A frame is defined as a data link layer “packet” which contains the header and trailer information required by a particular physical medium to one of ordinary skill in the art. This means that network layer packets are usually encapsulated to become frames.

Because both SOIs 140 can reside on the same IP subnetwork [as noted in the characteristics (2) of our hypothetical above], frames they exchange usually must be switched at layer two (Ethernet) rather than layer three (Internet Protocol). In the GPON standard, the upstream frames can be reflected downstream to all SOIs 140 with the appropriate SOI 140 identifying that the frame is for the intended recipient by reviewing the destination MAC address. A problem can exist if the LTN 120 doesn't know that a particular device bearing the frame's destination MAC address is on the same optical network 200A as the originating device. This can happen if the device 129 has been added recently and has not transmitted, or if it has not transmitted a frame in a long time, so that its MAC address has been automatically removed from the table of MAC addresses held by the LTN 120. This is understood by one of ordinary skill in the art.

The forwarding requirements can begin as soon as one SOI 140 has contacted its assigned softswitch and received the destination IP address for the voice traffic. The first SOI 140A in the example of FIG. 1 can first generate an Address Resolution Protocol (ARP) request at location A to find the Ethernet Media Access Control (MAC) address that corresponds to the known IP address. Because the first SOI 140A does not know the appropriate MAC address, it can broadcast this request to all SOIs 140 on the same layer 2 network.

For the ARP request to reach its destination, the LTN 120 sends the ARP request upstream at location B to the data service hub 110 to be processed by a data switch 190 at location C. LTN 120 also forwards the ARP request to the SOIs 140A-C within the first optical network 200A at locations E-G

The problem with this scenario is that if the LTN 120 doesn't recognize the destination MAC address of the frame, then it is going to have to flood the network, both upstream (to the Data Service Hub 110) and to all SOIs on the optical tap 130. The problem with this, is that the originating device, the first SOI 140A in the example, will get the frame. Not knowing that it originated the frame, it will inspect it and discover that the frame originated from a device having its MAC address. This will generate an error condition on the network, because usually no two devices should have the same MAC address.

As another possibly viable and conventional approach compared to forwarding frames upstream over the optical network 200A to the data service hub 110, the LTN 120 could transmit separate copies of the frame to the second and third SOIs 140B and 140C separately. This approach achieves the required effect of sending the reflected frame to all SOIs 140 except the originating first SOI 140A. The problem with this approach is its inefficiency. It fails to take advantage of the inherent multicast capability of the downstream optical network 200A. With only three SOIs 140 as illustrated in FIG. 1, the efficiency loss is usually not that significant.

However, G.984 passive optical networks can be deployed with more than 4,000 Port-IDs active on a particular optical network 200A. In those deployments, each single broadcast, multicast, or unknown destination frame usually must be copied 4,000 times by the LTN 120. The problem is particularly acute for multicast frames. Unlike the broadcast or unknown destination cases which typically result only in an occasional frame that the must replicate, multicast flows could conceivably force the LTN 120 to unnecessarily replicate a steady, high bandwidth stream.

One solution to this problem of forwarding information to SOIs 140 contained within the same optical network 200A could be to provide the Data Service Hub 110 with a Broadband Remote Access Server (BRAS) in place of Switch 190. A BRAS is special purpose hardware that can switch communications between layer one and layer two, where these layers refer to the Open Systems Interconnection (OSI) communication model. As known to one of ordinary skill in the art, the OSI is model of network architecture and a suite of protocols (a protocol stack) to implement it, developed by ISO in 1978 as a framework for international standards in heterogeneous computer network architecture. The OSI architecture is split between seven layers, from lowest to highest: one is the physical layer, two is the data link layer, three is the network layer, four is the transport layer, five is the session layer, six is the presentation layer, and seven is the application layer.

Each layer uses the layer immediately below it and provides a service to the layer above. The BRAS (not illustrated) receives information from the first SOI 140A and sends a new frame to the destination SOI 140, such as the third SOI 140C that is coupled to the same LTN 120 within the first optical network 200A. However, this conventional hardware solution would require a significant amount of processing time compared with the communications rate. Communications according to the G.984—GPON protocol are flowing at speeds of over two Gigabytes per second. Another problem with BRAS is that as of this writing, they are very expensive hardware relative to the other hardware and software components contained within a LTN 120.

Accordingly, a need exists in the art to provide LTNs 120 that can reflect communications between SOIs 140 that are coupled to the same LTN 120 and such that each LTN maintains the integrity of existing protocols, such as the G.984—GPON protocol, so that the LTNs 120 can service existing SOIs 140. A further need exists in the art for providing a method and system in which a SOI 140 can determine if a frame has been reflected by the LTN 120 and that if the SOI 140 was the originating source of the frame. Another need exists in the art for providing a method and system that can reflect communications between SOIs 140 that are coupled to the same LTN 120 in which the LTNs 120 and SOIs can be modified to recognize new fields of a modified protocol, such as a modification the G.984—GPON protocol, that indicate reflection and/or multicasting.

### SUMMARY OF THE INVENTION

A method and system for receiving upstream frames at a laser transceiver node (LTN) and reflecting them downstream for supporting communications between subscriber optical interfaces (SOIs) coupled to the same LTN can comprise a packet reflecting module that can prevent upstream frames from being sent further upstream to a data service hub if a media access control address of the frame is known by the LTN. A packet reflecting module can review the destination media access control (MAC) address of an upstream frame to determine if this address is connected to the tapped optical network on the LTN.

If the LTN cannot locate the destination MAC address, the packet reflecting module can modify one or more fields in the upstream frame to indicate that the frame has been reflected for downstream propagation to all devices over the optical network serviced by the same LTN. The packet reflecting module can also forward the frame upstream if the destination MAC address is unknown to the packet reflection module. The packet reflecting module can send the modified frame downstream to all SOIs that are serviced by the LTN.

At each SOI, fields of the frame can be reviewed to determine if the frame is acceptable to the reviewing SOI. If the reviewing SOI is also the source SOI that originated the frame, then the SOI can drop or discard the frame. Otherwise, if the reviewing SOI is not the originating SOI of the frame or if the frame is believed acceptable based on one of the fields in the frame, the SOI can then evaluate the MAC address of the frame. If it appears that the MAC address is supported by the reviewing SOI, it can pass the frame to any devices that may be coupled to the SOI. The devices coupled to an SOI can include, but are not limited to, a TV set top box, a television, a telephone, a computer, or any combination thereof.

According to a first exemplary aspect of the invention, as each SOI joins an optical network of a particular LTN, the packet reflecting module of the LTN can assign each joining SOI one or more port identifiers that are unique to the joining SOIs relative to other SOIs on the optical network for communications within an optical network corresponding to a single LTN. These port identifiers can be static, or constant, throughout operation of the SOIs and LTN. According to one exemplary aspect, the number of port identifiers that can be assigned to each SOI can be equal to the total number of port identifiers active within the optical network serviced by a particular LTN. This assignment of one or more port identifiers to the joining SOIs can make this solution backwards compatible for existing or legacy SOIs that may be serviced by a modified LTN that has the packet reflecting module. The port identifiers assigned to each SOI allows a particular SOI to receive frames when any of its assigned port identifiers match the port identifier of the received frame.

According to another exemplary aspect of the invention, in addition to providing each LTN with a packet reflecting module, each SOI can be provided with a downstream packet reviewing module that can determine if the reviewing SOI is the originating SOI of a particular received downstream frame. According to one exemplary aspect, the downstream packet reviewing module can perform some calculations on the port identifier field to determine if the reviewing SOI is the same as the originating SOI of the downstream frame. One exemplary calculation can include subtracting a predetermined value from the port identifier field to determine if the reviewing SOI is the same as the originating SOI of the downstream frame.

According to another exemplary aspect of the technology, each LTN can be provided with a packet reflecting module that changes values of new fields that have been added to an optical network protocol, such as the G.984—GPON protocol.

One new field of the optical network protocol can include a multicast port identifier flag field while another new field can include an expansion of the existing port identifier field. The multicast port identifier (ID) flag field can indicate whether or not a payload of a frame has been reflected by the LTN to a SOI. The port identifier (ID) field can provide thousands of unique traffic identifiers on the optical network in order to provide multiplexing. If the multicast Port-ID flag field of an upstream frame is zero, then the port ID field identifies the destination for the payload. If the multicast Port-ID flag field of a downstream frame is one, then the Port-ID field identifies the original source of the payload. With this exemplary aspect, each downstream port identifier reviewing module of an SOI can be designed to read the multicast Port-ID flag fields and Port-ID fields.

According to another exemplary aspect of the technology, each LTN can be provided with a packet reflecting module that adjusts newly active values of a protocol, such as the G.984—GPON protocol. The newly active fields can include revisions to the payload type indicator (PTI) fields of the G.984—GPON protocol. The revisions to the payload type indicator (PTI) can include defining two reserved values to indicate a multicast reflected frame. The port-ID in the header of a frame using the payload type indicator fields can designate the originating SOI of the frame prior to reflection by the LTN.

Each LTN can be provided with a packet reflecting module that adjusts the payload type indicator while each SOI could be provided with a downstream reviewing module that reads and interprets the payload type indicator.

### BRIEF DESCRIPTION OF THE DRAWINGS

FIG. 1 is a functional block diagram of an optical network of the conventional art that does not support packet reflection at the laser transceiver node.

FIG. 2 is a functional block diagram illustrating some core components of a modified laser transceiver node and corresponding backwards compatible SOI port identifier assignments according to one exemplary embodiment of the invention.

FIG. 3 is a functional block diagram illustrating some core components of a packet reflecting module used in the exemplary embodiment illustrated in FIG. 2.

FIG. 4 is a functional block diagram illustrating some core components of a modified laser transceiver node and modified SOIs according to another exemplary embodiment of the invention.

FIG. 5A is drawing illustrating a modification to a protocol in which new fields are added to the protocol such as a multicast Port-ID flag field and a redefinition of a Port-ID field according one exemplary embodiment of the invention.

FIG. 5B is a functional block diagram illustrating some core components of a packet reflecting module used in connection with the table of FIG. 5A.

FIG. 5C is a functional block diagram illustrating some core components of a downstream packet reviewing module used in connection with the table of FIG. 5A.

FIG. 6A is table illustrating a modification to a protocol in which two existing, reserved values of field in an existing protocol are modified to define reflected packets according to one exemplary embodiment of the invention.

FIG. 6B is a functional block diagram illustrating some core components of a packet reflecting module used in connection with the table of FIG. 6A.

FIG. 6C is a functional block diagram illustrating some core components of a downstream packet reviewing module used in connection with the table of FIG. 6A.

FIG. 7 is a logic flow diagram illustrating an exemplary method for supporting communications between SOIs coupled to the same LTN in an optical network that is backwards compatible with existing SOIs according one exemplary embodiment of the invention.

FIG. 8 is a logic flow diagram illustrating an exemplary method for supporting communications between SOIs coupled to the same LTN in an optical network in which SOIs are provided with a packet reviewing module according to one exemplary embodiment of the invention.

FIG. 9 is a logic flow diagram illustrating an exemplary method for supporting communications between SOIs coupled to the same LTN in an optical network in which the LTN and SOIs can utilize a multicast port identifier in combination with a port identifier field to track downstream reflected frames according to one exemplary embodiment of the invention.

FIG. 10 is a logic flow diagram illustrating an exemplary method for supporting communications between SOIs coupled to the same LTN in an optical network in which the LTN and SOIs can utilize a payload type indicator field to track downstream reflected frames according to one exemplary embodiment of the invention.

### DETAILED DESCRIPTION OF EXEMPLARY EMBODIMENTS

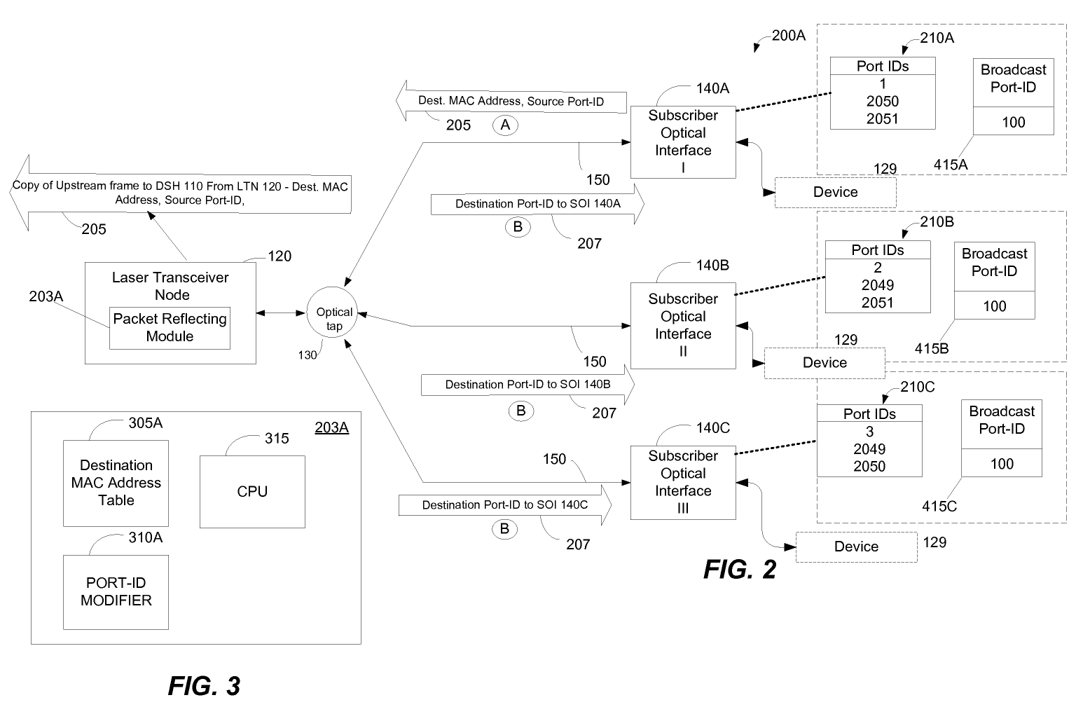

Referring now to the drawings, in which like reference numerals designate like elements, the system of FIG. 2 can maintain the integrity of an existing optical network protocol, and specifically the G.984—GPON protocol. In the inventive model, the LTN 120 can reflect back frames from SOIs 140 that are destined for SOIs 140 serviced by the same LTN 120.

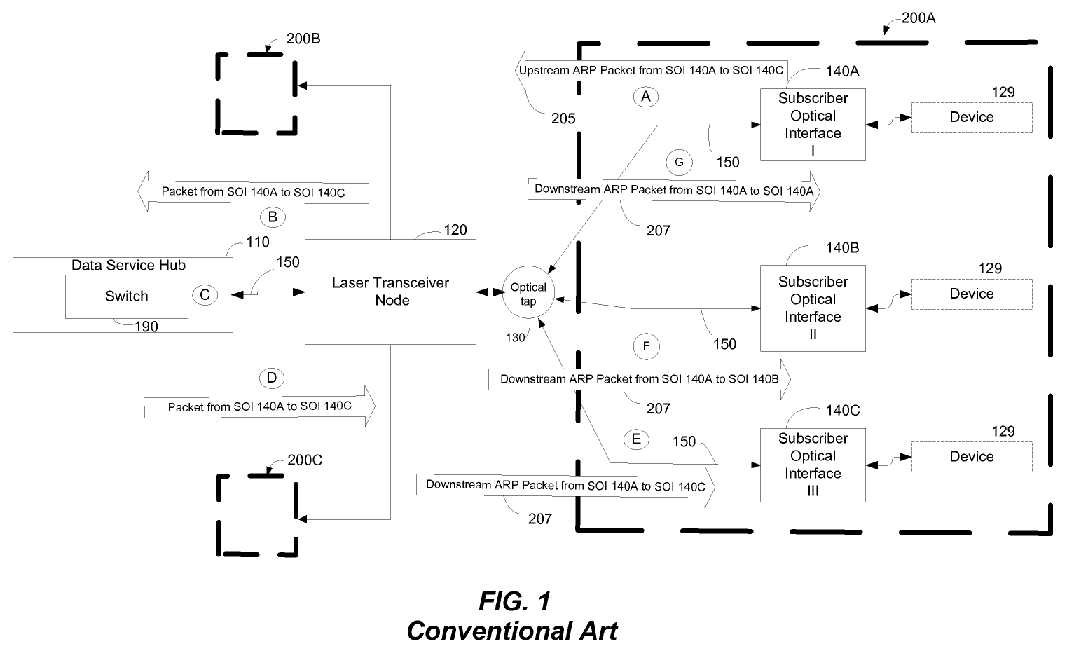

In this inventive model, the LTN 120 does not necessarily know which SOI 140 should respond to an ARP request if any ARP request described above is made, and therefore, it must reflect the frame to all SOIs 140 serviced by the same LTN 120 within optical network 200A. In this inventive model, the originating SOI 140 (such as the first SOI 140A in the example described above and illustrated in FIG. 1) should ignore the reflected frame because it originated the ARP request. If the originating first SOI 140A does not ignore its own ARP request, it will see the source MAC address for the frame as a duplicate of its own MAC address and erroneously report an error. Alternatively, the first SOI 140A in the inventive model could process the frame normally but forgo duplicate address checking; however, such a strategy sacrifices an extremely valuable troubleshooting technique.

There are two key requirements for this communication traffic pattern in this inventive model: First, the LTN 120 should reflect the upstream frame to all SOIs 140 on the optical network 200A. Secondly, the originating first SOI 140A should ignore the reflected frame.

In order to ignore the reflected frame, the first SOI 140A usually would need to know (a) that the frame has been reflected, and (b) that it (the first SOI 140A) was the originating source. The requirements for reflection are most clearly understood in the context of broadcast traffic such as ARP requests. Those requirements, however, are not limited solely to broadcast traffic. In some cases, the exact same requirements apply to unicast traffic. It is apparent that unicast frames that are destined for an SOI 140 on the same optical network 200A usually must be reflected by the LTN 120.

More significantly, however, there are cases where unicast frames usually must be reflected to all SOIs 140 on the optical network 200A, and those reflected frames should be ignored by the originating SOI 140. To continue the example of a phone conversation between neighbors, consider the following:

The LTN 120 can maintain a cache associating destination MAC addresses with SOIs 140, and the LTN 120 periodically removes stale entries from this cache. Each SOI 140 can maintain a cache associating destination MAC addresses with destination IP addresses, and the SOI 120 can periodically remove stale entries from this cache. Consider the case in which cache timeouts are such that the entry for the third SOI 140C in the LTN 120's cache expires before the entry in the first SOI 140A's cache. In this scenario, the first SOI A can recall the destination MAC address it needs for any communication stream (which can eliminate the need to re-issue an ARP request), but the LTN 120 will no longer know which SOI 140 corresponds to the destination MAC address.

When the first SOI 140A sends the next frame for the third SOI 140C, the LTN 120 will in this case consider that frame's destination an unknown MAC address. Since the LTN 120 does not know the location of the destination MAC address, it must reflect the frame to all SOIs 140 on the optical network 200A.

This example in which the frame is sent upstream to the data service hub 110 and in which a LTN 120 reflects frames downstream illustrate the flooding behavior required for broadcast traffic and for frames with unknown destination MAC addresses. A third class of communication traffic—multicast traffic originating at an SOI 140—should receive the same treatment. Although there are few practical applications for multicast sourcing in residential access networks at the time of this writing, G.984 optical networks 200A may well be deployed in environments such as university campuses that do require support for multicast generation. In these future cases, the forwarding requirements are the same.

The LTN 120 usually must reflect frames “downstream” to all SOIs 140, but the originating SOI 140, such as the first SOI 140A, should ignore the reflected traffic because it was the source of the reflected frame.

Referring now to FIG. 2, this Figure is a functional block diagram illustrating some core components of a modified laser transceiver node (LTN) 120 and corresponding backwards compatible SOI port identifier (Port-ID) assignments 210 according to one exemplary embodiment of the invention. In this exemplary embodiment, the LTN 120 can be provided with a packet reflecting module 200A.

The LTN 120 can further include other elements such as a routing device that uses a look up table, a laser transmitter, an optical receiver, a multiplexer, and diplexer, just to name a few. Further details of the LTN 120 are described in U.S. Pat. No. 6,973,271, entitled, “System and Method for Communicating Optical Signals between a Data Service Provider and Subscribers”, the entire contents of which are hereby incorporated by reference.

The LTN 120 can be coupled to several subscriber optical interfaces (SOIs) 140 via optical waveguides 150 and an optical tap 130. Each SOI 140 can further include other elements such as an optical diplexer, optical receiver, laser transmitter, a processor, and a data interface, just to name a few. Further details of the SOI 140 are also described in U.S. Pat. No. 6,973,271, entitled, “System and Method for Communicating Optical Signals between a Data Service Provider and Subscribers”, the entire contents of which are hereby incorporated by reference. Each SOI 140 can be coupled to one or more devices 129 such as a TV set top box, a television, a telephone, a computer, or any combination thereof (not illustrated). Each SOI 140 can be assigned a Port-identifier or Port-ID.

Port-IDs are usually dependent on the communication protocol that may be used to support communications over the optical network 200A. One such exemplary communication protocol is the International Telecommunications Union (ITU)—G.984—Gigabit capable Passive Optical Network (GPON) protocol. Existing G.984 standards define the Port-ID as a simple 12-bit value that can range from 0 to 4095. This definition allows up to 4096 Port-IDs on a single optical network 200A. To support efficient reflection of downstream frames 205 to downstream SOIs 140, according to one exemplary embodiment, Port-ID values can be limited to the 11 least significant bits of the Port-ID field, with the most significant bit always set to zero. With this exemplary convention, Port-ID values can be limited to the range from 0 to 2047, so a single optical network 200A can only support 2048 different Port-IDs. However, other conventions can be adopted without departing from the scope of the invention.

Port-ID values from 2048 to 4095 are not used by the Invention to represent standard Port-IDs. Instead, according to the Invention, they represent multicast Port-IDs. (“Multicast,” in view of these Port-ID designations includes true broadcast traffic and traffic that usually must be flooded because its destination MAC address is unknown.)

With this invention, in effect, the most significant bit of the Port-ID can become a multicast indication. The remaining 11 bits of multicast Port-IDs specify a standard Port-ID that can be exempt from multicast distribution. For example, a multicast Port-ID of 2049 represents a Port-ID for multicast traffic; frames arriving in an SOI 140 with this Port-ID should be replicated to all Port-IDs except Port-ID 1, as 2049 less 2048 is 1. With this exemplary convention, it becomes fairly simple to see how a LTN can efficiently replicate multicast SOI-to-SOI traffic. The LTN can take the Port-ID upon which the traffic arrives, add 2048 to that value, and send the reflected frame to the resulting multicast Port-ID.

One benefit of the multicast Port-ID concept is its backwards compatibility with existing G.984 systems, and specifically with existing subscriber optical interfaces (SOIs) 140 that do not undergo any hardware changes. So long as existing deployments restrict Port-ID values to the range from 0 to 2047, multicast Port-IDs may have no effect on their operations. Multicast Port-IDs may also be deployed in a limited manner with existing systems.

According to an exemplary embodiment, the SOI 140 can support multicast Port-IDs as normal. Whenever the LTN 120 needs to reflect a frame to all SOIs 140 on an optical network 200A, it can use the multicast Port-ID that corresponds to the source (unicast) Port-ID of the originating SOI 140.

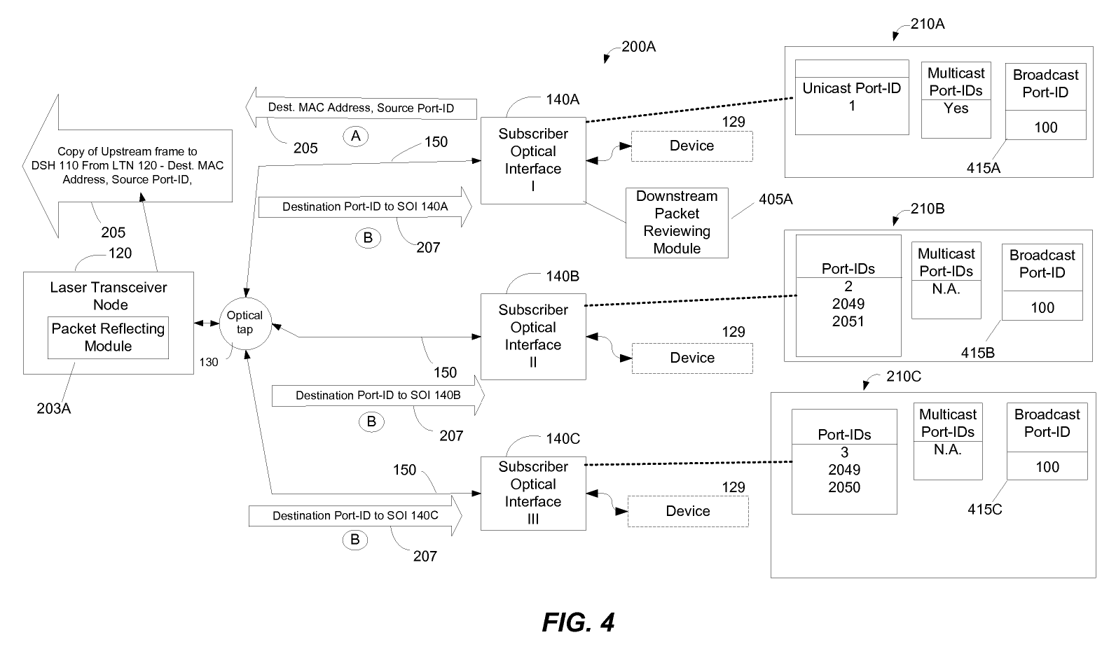

Existing SOIs 1040 on the optical network 200A that support multicast Port-IDs can operate as expected (See first SOI 140A of FIG. 4, discussed below). They receive and process all frames arriving on a multicast Port-ID except for those frames whose multicast Port-ID corresponds to the SOI's own unicast Port-ID.

SOIs 140 on the optical network 200A that do not support multicast Port-IDs (See all SOIs 140 of FIG. 2, See only second and third SOIs 140B, C of FIG. 4) must be manually provisioned or set to receive traffic on each multicast Port-ID other than those Port-IDs corresponding to their unicast Port-IDs. For these SOIs 140, the multicast Port-ID will appear to be a normal unicast Port-ID because the optical network protocol contemplated has not established Port-IDs for multicast communication traffic. If, in the example network 200A discussed so far, the SOIs 140 do not fully support multicast Port-IDs, this approach requires that each SOI 140 be provisioned for those Port-IDs as if they were unicast Port-IDs.

In a worst-case, each SOI 140 would have to be provisioned with a number of Port-IDs equal to the total number of Port-IDs active on the optical network 200A. In many deployments, however, the worst-case configuration will usually not be required. In fact, only Port-IDs which could originate traffic that the LTN 120 might reflect need be included. Port-IDs for Internet access via the Point-to-Point Protocol over Ethernet (PPPoE), for example, would usually not require reflection.

The unicast Port-ID assignments 210A-210C of FIG. 2 would be made by the LTN 120 when each SOI 140 is coupled to the network 200A via optical waveguides 150. These Port-ID assignments are usually statically defined by the LTN 120. That is, each Port-ID assignment 210, which can include one or more Port-IDs, is permanent relative to a particular SOI 140.

If the first SOI 140A wants to communicate with another SOI 140 (whether or not on the same optical network 200A), the first SOI 140A at location A would transmit an upstream frame 205 that has a destination MAC address corresponding to the intended SOI. The upstream frame 205 would also contain the source Port-ID that corresponds to the first SOI 140A which is the number one according to the exemplary embodiment illustrated in FIG. 2.

When the LTN 120 receives the upstream frame 205, the packet reflecting module 203 will review the destination MAC address of the upstream frame 205 to determine if the destination MAC address is known by the LTN 120. Specifically, the packet reflecting module 305A will access a table 305 to determine if the destination MAC address of the upstream frame 205 matches any MAC addresses contained in the table 305. If there is no match with any of the addresses in the table 305, the LTN 120 does not recognize the destination MAC address so it must flood the frame 207 to all ports of the SOIs 140 that the LTN 120 supports. Therefore, the packet reflecting module 203 can add a predetermined value to the source Port-ID of the upstream frame 205 before flooding the downstream frame 207 to all SOIs 140 that are coupled to the LTN 120.

According to one exemplary embodiment, the packet reflecting module 203 can add the value of 2048 to the Port-ID of the upstream frame 205, which is one in this example. Therefore, the Port-ID of the reflected downstream frame 207 becomes the value of 2049 in this example. The reflected downstream frame 207 with the Port-ID value of 2049 is then sent by the LTN 120 to all of the SOIs 140 at locations B which correspond with the first, second, and third SOIs 140A-140C as set forth in this exemplary embodiment.

At each SOI 140, the destination Port-ID of 2049 is reviewed by each SOI 140. Only the first SOI 140A of this exemplary embodiment does not have a matching Port-ID (because it was the SOI that sent the frame). In absence of the inventive method of identifying the SOI 140A that is the originating SOI 140, the first SOI 140A would see the MAC address of the downstream frame as the source MAC address and will usually generate an alarm because there can't be two devices with the same MAC address.

Therefore, the first SOI 140A will not process this reflected frame 207, while the second and third SOIs 140B and 140C will process the reflected frame 207. In this specific case, the second and third SOIs 140B and 140C were assigned Port-IDs of 2049 and therefore, any frames 207 with this Port-ID (2049) would be accepted by them and allowed to pass through to devices 129. Meanwhile, the first SOI 140A was not assigned the Port-ID of 2049 and therefore, it would reject or discard any frames with the Port-ID value of 2049. In summary, the Port-ID assignments 210 that are greater than 2048 in FIG. 2 indicate which SOIs will accept the downstream packet.

The packet reflecting module 203 will also send a copy of the packet upstream to the data service hub 110 because the destination MAC address could be outside of the LTN's 120 network 200A. Next, after the packet reflecting module 203 forwards the packet upstream from the LTN 120 or after the second or third SOIs 140B, 140C evaluate the downstream packet 207 to determine if one of their devices 129 has a matching MAC address, the device 129 (not illustrated) upstream from the LTN 120 or a device 129 coupled to one of the SOIs 140 within the optical network 200A may have the correct MAC destination address. The device 129 with the correct MAC destination address will send an acknowledgement message to the LTN 120. With this acknowledgement message, the packet reflecting module 203 can update its MAC destination address table 305 to indicate if the MAC address is served inside or outside of the packet reflecting module's 203 optical network 200A.

Once its MAC address destination table 305 has been updated, the packet reflecting module 203 will not need to forward the next frame with the same MAC address destination to all of its SOIs 140 AND upstream to the data service hub 110. In this scenario in which the packet reflecting module 203 identifies a match between the destination MAC address in the upstream frame 205 and its table 305, the packet reflecting module 203 will know either to forward the frame upstream to the data service hub 110 or downstream to its SOIs 140. If the packet reflecting module 203 determines that the destination MAC address matches addresses that are in its optical network 200A, the packet reflecting module 203 will not modify the Port-ID of the upstream frame 205, and therefore, the Port-ID will remain the same as the upstream Port-ID.

In other words once the correct location of a MAC address of a frame is known, the frame is sent as a unicast frame, intended for one and only one SOI 140. The source SOI 140 then knows to ignore the frame, since the destination MAC address differs from its own. The problem faced with multicast frames is that NO SOI 140 can discard a multicast frame without examining it. Adding 2048 to the port-ID defines a frame as a multicast frame.)

Referring now to FIG. 3, this figure is a functional block diagram illustrating some core components of a packet reflecting module 203A that can be used in the exemplary embodiment illustrated in FIG. 2. The packet reflecting module 203A can comprise a Port-ID modifier 310A that can change the Port-ID field of downstream frames 205 to indicate the destination of the reflected frame 207 that is based on the source Port-ID. According to one exemplary embodiment, the Port-ID modifier 310A can add the value of 2048 to the source Port-ID value of the upstream frame 205 in order to provide the new destination Port-ID value for the downstream frames 207 that are to be reflected by the LTN 120. However, other values greater or less than 2048 are not beyond the invention.

The Port-ID modifier 310A can be coupled to a general purpose central processing unit 315A. Alternatively, instead of being embodied in a separate piece of hardware, the Port-ID modifier 310A can comprise software that is executed or run by the CPU 315A.

The packet reflecting module 203A can further comprise a destination MAC address table 305A. The destination MAC address table 305A can provide a listing of MAC addresses for SOIs 140 that are coupled to the LTN 120 so that the Port-ID modifier 310A or CPU 315A can determine if an upstream frame 205 is intended for another SOI 140 known by the same LTN 120. The destination MAC address table 305A can reside in memory of the Port-ID modifier 310A or in memory of the CPU 315A. If the MAC address is known, then it is not necessary to flood or multicast the frame 207 to all SOIs 140 and to the upstream data service hub 110. In this case in which the destination MAC address is known, packet reflecting module 203 will send the frame 207 to one of its SOIs 140.

As noted above, if the MAC address is known by the LTN 120, then it is not necessary to modify the Port-id. Rather, the frame can be sent directly to one SOI 140 with the corresponding MAC address. This frame destined for a single SOI 140 with MAC address known by the LTN 120 will arrive at all SOIs 140, but the difference is that the frame will be transmitted by the LTN 120 as a unicast frame. That is, the frame will be sent such that it is received by ONLY the one SOI 140 with the matching MAC address. All other SOIs 140 will ignore the frame because it is a unicast frame without a MAC address matching one at a particular reviewing SOI 140. Only if it is a multicast or broadcast frame will a frame be reviewed by an SOI 140 other than the one with the correct destination MAC address.

If the MAC address is not known, that is, it is not found in Destination MAC Address Table 305, then Port-ID Modifier 310 will modify the port number as described above, and the frame 207 will be flooded to all SOIs 140 including the first SOI 140A.

### Alternate Exemplary Embodiment—Modified SOI 140A and Legacy SOIs 140B, C

Referring now to FIG. 4, this Figure is a functional block diagram illustrating some core components of a laser transceiver node 120 and SOIs 140 according to another exemplary embodiment of the invention. This figure is similar to the functional block diagram FIG. 2 and therefore, only the differences between these Figures will be discussed herein. In FIG. 2, none of the SOIs 140 were built to support multicast port IDs. In FIG. 4, the first SOI 140A is built to support multicast port IDs, whereas the other two SOIs, the second SOI 140B and third SOI 140C, are not and are the same type as those illustrated in FIG. 2.

In the exemplary embodiment illustrated in FIG. 4, the first SOI 140A has been modified to have a downstream packet reviewing module 405A while the remaining two SOIs 140B, C do not have a downstream packet reviewing module 405A. The downstream packet reviewing module 405A can analyze downstream frames 207 that have been modified by the packet reflecting module 203A and it can support multicast port IDs. The downstream reviewing module 405A can comprise hardware or software, or a combination thereof.

The downstream packet reviewing module 405A can analyze the downstream frame 207 to determine if the first SOI 140A originated the source upstream frame 205. In this case, the downstream packet reviewing module 405A can subtract the value of 2048 from the Port-ID of downstream frame 207 and determine that the source Port-ID for the upstream frame 205 was one. In view of this, the downstream packet reviewing module 405A can discard or drop the downstream frame 207.

Because the first SOI 140A is capable of supporting multicast port IDs as well as analyzing reflected downstream frames 207, it is not necessary to pre-assign it all of the unicast port IDs that must be assigned to SOIs 140B and 140C. It is assigned its single (in this case) unicast Port-ID, and from this single unicast Port-ID the downstream packet reviewing module 405A (through performing its calculations) knows to ignore any frames 207 coming in with its corresponding or matching multicast port ID. If a multicast frame 207 is received, the downstream packet reviewing module 405A will subtract 2048 from the port-ID. If the resultant port-ID matches the port-ID(s) of that SOI, then the frame 207 must have come from that SOI 140 and it is discarded. If the resultant port-ID does not match the port ID(s) of that SOI, then the frame 207 came from somewhere else and should be checked to see if the destination address is known to that SOI.

### Alternate Exemplary Embodiment—New Fields in Protocol and Modified SOIs 140

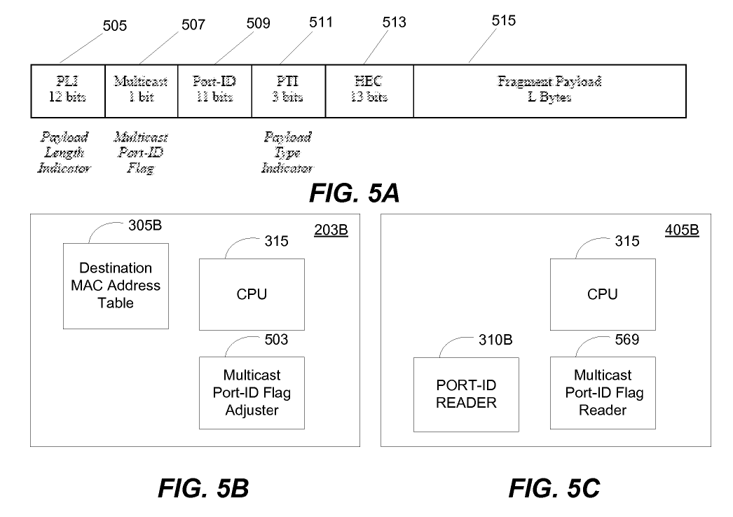

Referring now to FIG. 5A, this figure is a chart 500 illustrating a modification to an optical network protocol, such as the G.984.3 protocol, in which new fields are added to the protocol such as a multicast Port-ID flag field 507 and a redefinition of a Port-ID field 509 according one exemplary embodiment of the invention.

FIG. 5A is one embodiment of a modified GPON Encapsulation Mode (GEM) protocol that is part of the G.984.3 protocol. The inventive GEM header can comprise a Payload length indicator (PLI) field 505, a Multicast Port-ID flag field 507, a Port ID 509, a Payload type indicator (PTI) 511, and a 13-bit header error control field 515. The GEM header is positioned before the fragment payload 515. The Payload length indicator (PLI) field 505, a Payload type indicator (PTI) 511, and a 13-bit header error control field 515 are known to one of ordinary skill in the art and are discussed by the G.984.3 protocol, the contents of which is hereby incorporated by reference.

The Multicast Port-ID Flag field 507 can be used to indicate whether or not the payload has been reflected by the LTN 120 from a SOI 140 on the optical network 200A. A value of one (1) can identify reflected frames. If the Multicast Port-ID Flag value 507 is one (1), then the Port-ID field must be checked to verify whether or not the frame 207 originated at that SOI 140. The Port-ID field 509 can be used to provide 2048 unique traffic identifiers on the optical network 200A to provide traffic multiplexing. If the Multicast Port-ID Flag value 507 is zero (0) which means that the downstream frame 207 was not multicasted by the laser transceiver node 120, then the frame 207 may be handled based on the destination MAC address. According to this exemplary embodiment, the Port-ID field is redefined from twelve bits to eleven bits.

Hardware or software (or both) is needed to support the modified GEM protocol of FIG. 5A. Referring now to FIG. 5B, this figure is a functional block diagram illustrating some core components of a packet reflecting module 203B used in connection with the table of FIG. 5A according to another exemplary embodiment. The packet reflecting module 203B of FIG. 5B can comprise a multicast-port ID flag adjuster 503. If the multicast-port ID flag adjuster 563 determines that an upstream frame 205 is to be multicast when reflected, it can change the multicast-port ID flag value 507 from zero to one.

The packet reflecting module 203B can further comprise a destination MAC address table 305B. The destination MAC address table 305B can provide a listing of MAC addresses for SOIs 140 that are coupled to the LTN 120 so that multicast-Port ID adjuster 563 or CPU 315B can determine if an upstream frame 205 is intended for another SOI 140 serviced by the same LTN 120. The destination MAC address table 305B can reside in memory of the multicast-Port ID adjuster 563 or in memory of the CPU 315B.

FIG. 5C is a functional block diagram illustrating some core components of a downstream packet reviewing module 405B used in connection with the table of FIG. 5A. The downstream packet reviewing module 405B can analyze downstream frames 207 that have been modified by the packet reflecting module 203B of FIG. 5B.

The downstream packet reviewing module 405B can comprise a multicast-port ID evaluator 569 and a Port-ID reader 310B. The multicast-port ID evaluator 569 can review downstream frames 207 to determine if the multicast-port ID field 507 has been changed to a value of one (1) to indicate the downstream frame 207 is a multicast frame 207. In such a case, the Port-ID reader 569 compares the Port-ID value of the downstream frame 207 with the Port-ID assigned to the subscriber optical interface 140. If the Port-ID value in the reflected frame 207 matches the Port-ID assigned to the SOI 140, then the downstream packet reviewing module 405B can discard or drop the downstream frame 207. As mentioned above, the Port-ID of the downstream frame 207 is the Port-ID of the source or originating SOI 140 that sent the upstream frame 205.

If the Port-ID value in the reflected frame 207 does not match the Port-ID assigned to the SOI 140, then the downstream packet reviewing module 405B can pass the frames 207 to all of the devices 129 coupled to the SOI 140. If the multicast port ID value is zero which means that the downstream frame 207 is not a multicast frame 207, then if the destination MAC address matches, the downstream frame 207 will be immediately passed to the appropriate device 129 (having the correct MAC address) coupled to a respective SOI 140.

The downstream packet reviewing module 203B can comprise a general purpose central processing unit 315 that is coupled to the multicast-port ID evaluator 566 and Port-ID modifier. Alternatively, instead of being embodied in separate pieces of hardware, both the multicast-port ID evaluator 566 and Port-ID evaluator 569 can comprise software that is executed or run by the CPU 315B.

### Alternate Exemplary Embodiment—New Fields in Protocol and Modified SOIs 140

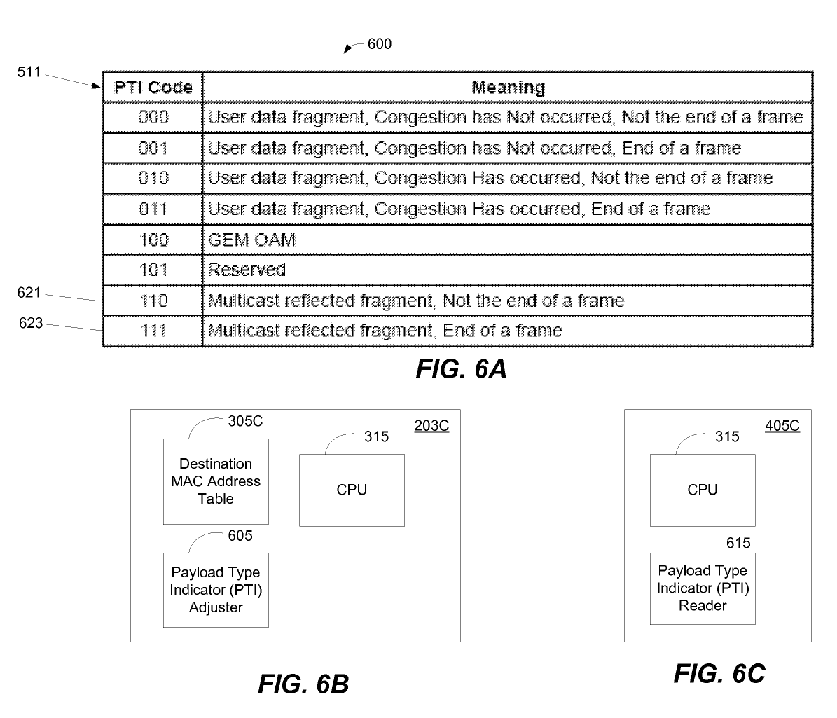

Referring now to FIG. 6A, this figure is table 600 illustrating a modification to an existing optical network protocol in which two existing, reserved values 621 and 623 of a field are modified to define reflected frames 207 according to one exemplary embodiment of the invention. According to this exemplary embodiment, the GEM protocol payload type indicator (PTI) 511 (See FIG. 5A) can be expanded. The G.984.3 protocol currently defines five of eight possible values for this three-bit field. Two of those reserved values 621, 623 could be defined as a multicast reflected frame. The Port-ID in the header field 509 can indicate the original source of the frame prior to reflection.

Referring now to FIG. 6B, this figure is a functional block diagram illustrating some core components of a packet reflecting module 203C used in connection with the table of FIG. 6A. The packet reflecting module 203C of FIG. 6B can comprise a Payload Type Indicator (PTI) adjuster 605 that can change the payload type indicator value to indicate a reflected frame 207 if the PTI adjuster 605 determines that an upstream packet 205 is intended for a SOI 140 serviced by the LTN 120. The PTI adjuster 605 can be coupled to a general, purpose central processing unit 315. Alternatively, instead of being embodied in a separate piece of hardware, the PTI adjuster 605 can comprise software that is executed or run by the CPU 315.

The packet reflecting module 203C of FIG. 6B can further comprise a destination MAC address table 305C. The destination MAC address table 305C can provide a listing of MAC addresses for SOIs 140 that are coupled to the LTN 120 so that the PTI adjuster 605 or CPU 315A can determine if an upstream frame 205 is intended for another SOI 140 serviced by the same LTN 120. The destination MAC address table 305A can reside in memory of the PTI adjuster 605 or in memory of the CPU 315.

Referring now to FIG. 6C, this Figure is a functional block diagram illustrating some core components of a downstream packet reviewing module 405C used in connection with the table of FIG. 6A. The packet reviewing module 405C can comprise hardware in one exemplary embodiment such as a central processing unit. However, software embodiments or a combination of hardware and software are not beyond the scope of the invention.

In the exemplary embodiment illustrated in FIG. 6C, the downstream packet reviewing module 405C can analyze downstream frames 207 that have been modified by the packet reflecting module 203C. The packet reviewing module 405C can comprise a payload type indicator (PTI) reader 615. The PTI reader can analyze the PTI code of the PTI field 511 to determine if a downstream frame 207 has been reflected by the packet reflecting module 203C.

### Exemplary First Process Flow Corresponding to System of FIGS. 2-3

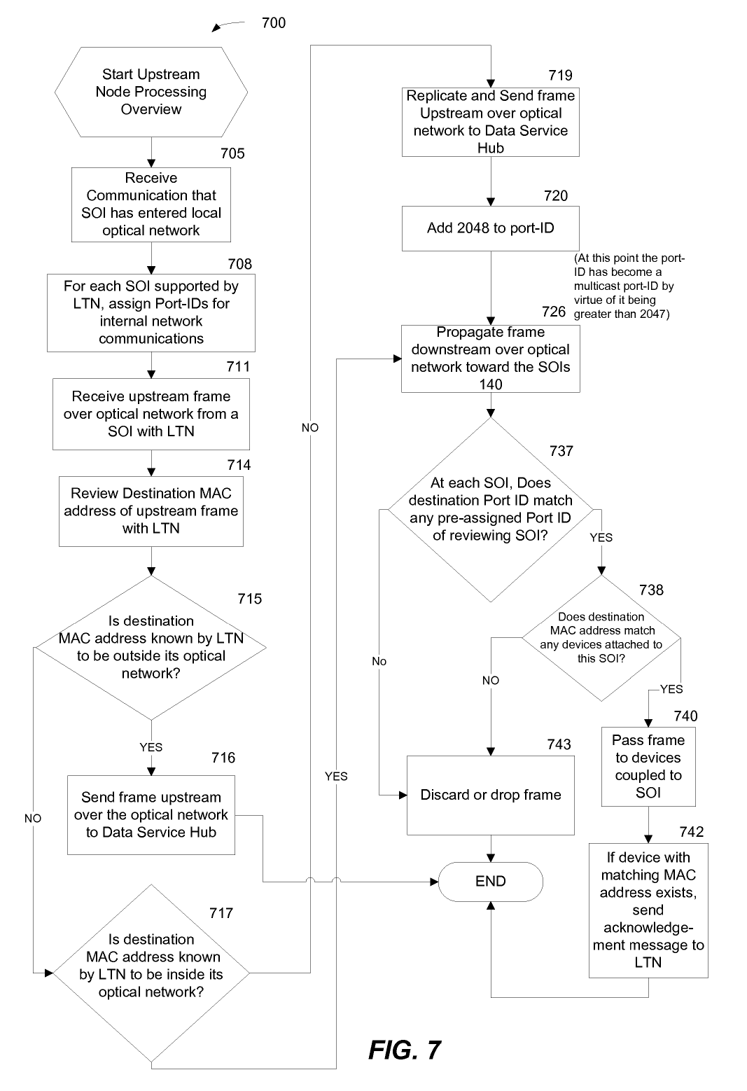

Referring now to FIG. 7, this Figure is a logic flow diagram illustrating an exemplary method for supporting communications between SOIs 140 coupled to the same LTN 120 in an optical network that is backwards compatible with existing SOIs 140 according one exemplary embodiment of the invention.

One of ordinary skill in the art will appreciate that process and functions described in connection with FIGS. 7-10 can be performed by various different general processors. Alternatively, the process and functions described with respect to FIGS. 7-10 can be performed by firmware code executed on a microcontroller, microprocessor, or DSP processor state machines implemented in application specific or programmable logic; or numerous other forms without departing from the invention.

In other words, the invention may be provided as a computer program which may include a machine-readable medium having stored thereon instructions which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions.

Certain steps in the processes or process flow described in all of the logic flow diagrams referred to below must naturally precede others for the invention to function as described. However, the invention is not limited to the order of the steps described if such order or sequence does not alter the functionality of the present invention. That is, it is recognized that some steps may be performed before, after, or in parallel other steps without departing from the scope and spirit of the present invention.

Further, one of ordinary skill in the art would be able to write such a computer program or identify the appropriate hardware circuits to implement the disclosed invention without difficulty based on the flow charts and associated description in the application text, for example. Therefore, disclosure of a particular set of program code instructions or detailed hardware devices is not considered necessary for an adequate understanding of how to make and use the invention. The inventive functionality of the claimed computer implemented or hard wired processes will be explained in more detail in the following description in conjunction with the Figures illustrating process flows.

Referring back to FIG. 7, Step 705 is the first step of the method or process 700 corresponding to the system illustrated in FIG. 2 in which the packet reflecting module 203A receives a communication that an SOI 140 has joined the optical network 200A supported by the LTN 120. Next, in step 708, for each SOI 140 that is supported by the LTN 120, the packet reflecting module 203A assigns unique Port-IDs for internal network communications. That is, the packet reflecting module 203A assigns unique Port-IDs to SOIs 140 that are coupled to the same LTN 120.

Next, in step 711, the packet reflecting module 203A within the LTN 120 receives an upstream frame 205 from an SOI 140. In step 714, the packet reflecting module 203A reviews the destination MAC address of the upstream frame 205 and compares the MAC address to the list of MAC addresses stored in the destination MAC address table 305.

In decision step 715, the packet reflecting module 203 determines if the destination MAC address is supported by an upstream device 129 (not illustrated), outside of its optical network 200A based on the comparison to the destination MAC address table 305. If the inquiry to decision step 715 is negative, then the “No” branch is followed to decision step 717. If the inquiry to decision step is positive, the “Yes branch is followed to step 716 in which the frame 205 is forwarded upstream over the outside optical network to the data service hub 110. After step 716, the process ends.

In decision step 717, the packet reflecting module 203 determines if the destination MAC address is supported by the LTN 120 based on the comparison to the destination MAC address table 305 in step 714. If the inquiry to decision step 717 is negative, then the “No” branch is followed to step 719 in which the upstream frame 205 is replicated and sent upstream over the outside optical network to the data service hub 110. Next, in step 720, the packet reflecting module 203A adds the value of 2048 to the value of the retrieved originating Port-ID. However, other values greater or lesser than the value of 2048 are not beyond the scope of the invention. The packet reflecting module 203A then places the modified Port-ID into the destination Port-ID of the reflected downstream frame 207.

If the inquiry to decision step 717 is positive meaning that there is match between the destination MAC address of the upstream frame 205 and the destination MAC address table 305 and also meaning that the destination MAC address is on the LTN's 120 optical network 200A, then the “Yes” branch is followed to step 726 in which the packet reflecting module 203A of FIG. 2 reflects the upstream frame 205 as a downstream frame 207 without changing the destination Port-ID.

In decision step 737, at each legacy SOI 140 of FIG. 2, it is determined if the destination Port-ID of the downstream frame 207 matches the Port-ID of a particular reviewing SOI 140. If the inquiry to decision step 737 is positive, then the “Yes” branch is followed to decision step 738. In decision step 738, it is determined if the destination MAC address matches any devices 129 coupled to the reviewing SOI 140. If the inquiry to decision step 738 is positive, the “Yes” branch is followed to step 740. If the inquiry to decision step 738 is negative, the “No” branch is followed to step 743.

If the inquiry to decision step 737 is negative meaning that the downstream destination Port-ID does not match the “accepted” Port-IDs that are assigned to a particular SOI 140, then the “No” branch is followed to step 743. In step 743, the downstream frame 207 is either dropped or discarded. The process then ends.

If the inquiry to decision step 738 is positive meaning that a device 129 is coupled to the reviewing SOI 140 with a matching destination MAC address, the “Yes” branch is followed to step 740. In step 740, downstream frame 207 is allowed to pass to the device 129 with the matching destination MAC address. Then, in step 742, if a device 129 with a matching destination MAC address exists, it will send an acknowledgement message back upstream to the LTN 120. The process then ends.

### Exemplary Second Process Flow Corresponding to System of FIG. 4

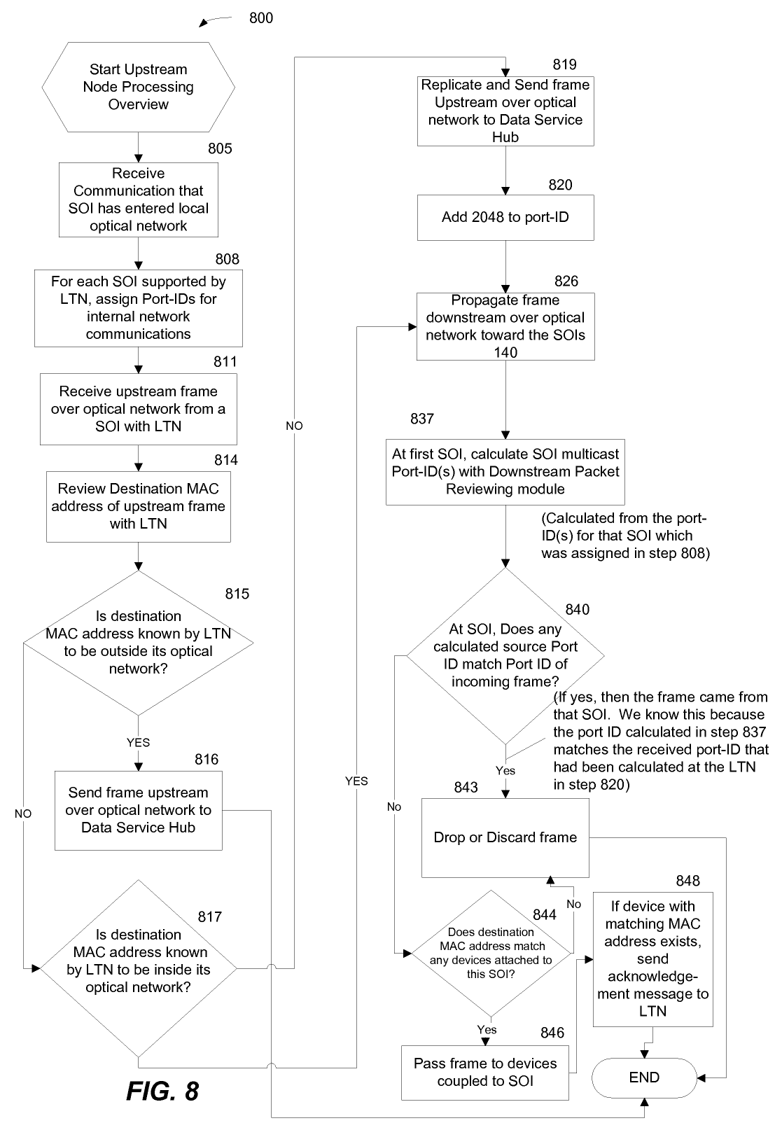

FIG. 8 is a logic flow diagram illustrating an exemplary method 800 for supporting communications between SOIs 140 of FIG. 4 coupled to the same LTN 120 in an optical network 200A in which only the first SOI 140A is provided with a packet reviewing module 405A according to one exemplary embodiment of the invention. The logic flow diagram of FIG. 8 is very similar to the logic flow diagram of FIG. 7 because all processing in the LTN 120 and by the packet reflecting module 203A prior to a SOI 140 receiving a downstream frame 207 in Step 737 is the same. Therefore, only the steps after this point that address the downstream frames 207 and only the first SOI 140A equipped with packet reviewing module 405A will be discussed.

In step 837, the downstream packet reviewing module 405A (that is present in only the first SOI 140A) will perform a calculation on the destination Port-ID of the downstream frame 207. According to one exemplary embodiment, the downstream packet reviewing module 203A will subtract a value of 2048 from the destination Port-ID of the downstream frame 207. However, other types of calculations are not beyond the scope of the invention, such as addition, multiplication, division, etc. depending on how the packet reflecting module 203A modified the downstream destination Port-ID of the downstream frame 207 to indicate reflection.

Next, in decision step 840, the downstream packet reviewing module 203A will determine if the calculated Port-ID value from Step 837 is identical to the Port-ID of the reviewing SOI 140. If the inquiry to decision step 840 is positive meaning that source Port-ID of the downstream frame 207 is the same as the reviewing SOI 140, the “Yes” branch will be followed to step 843 in which the modified downstream frame 207 will be dropped or discarded. The process then ends.

If the inquiry to decision step 840 is negative, then the “No” branch is followed to decision step 844. In decision step 844, it is determined if the destination MAC address matches any devices 129 coupled to the reviewing SOI 140. If the inquiry to decision step 844 is positive, the “Yes” branch is followed to step 846. If the inquiry to decision step 844 is negative, the “No” branch is followed to step 843 in which the frame 207 is dropped or discarded. The process then ends.

If the inquiry to decision step 844 is positive meaning that a device 129 is coupled to the reviewing SOI 140 with a matching destination MAC address, the “Yes” branch is followed to step 846. In step 846, downstream frame 207 is allowed to pass to the device 129 with the matching destination MAC address. Then, in step 848, if a device 129 with a matching destination MAC address exists, it will send an acknowledgement message back upstream to the LTN 120. The process then ends.

### Exemplary Third Process Flow Corresponding to System of FIG. 5

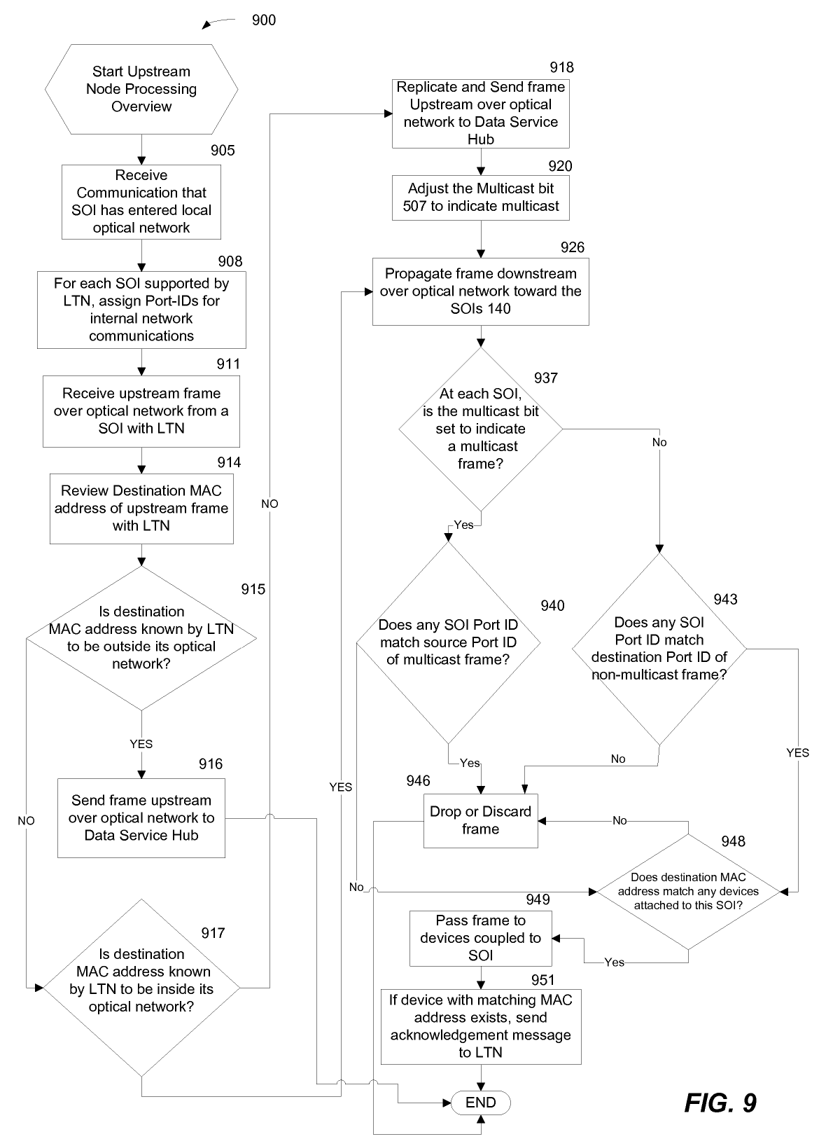

Referring now to FIG. 9, this figure is a logic flow diagram illustrating an exemplary method 900 for supporting communications between SOIs 140 coupled to the same LTN 120 in an optical network 200A in which the LTN 120 and SOIs 140 can utilize a multicast port identifier field in combination with a port identifier field to track downstream reflected frames 207 according to one exemplary embodiment of the invention.

Step 905 is the first step of the method or process 900 in which the packet reflecting module 203B receives a communication that an SOI 140 has joined the optical network 200A supported by the LTN 120. Next, in step 908, for each SOI 140 that is supported by the LTN 120, the packet reflecting module 203B of FIG. 5B assigns unique Port-IDs for internal network communications.

That is, the packet reflecting module 203B assigns unique Port-IDs to SOIs 140 that are coupled to the same LTN 120. However, the amount of Port-IDs assigned to SOIs 140 in this embodiment will be significantly less than the amount set forth in FIG. 2. Usually, in this exemplary embodiment, each SOI 140 can be assigned one or two Port-IDs because this exemplary embodiment is relying upon new fields in the optical network protocol in order to determine if a frame 207 has been reflected instead of relying on the value of the Port-ID to determine reflection status.

In step 911, the packet reflecting module 203B receives an upstream frame 205 from an SOI 140. In step 914, the packet reflecting module 203B reviews the destination MAC address of the upstream frame 205 and compares the MAC address to the list of MAC addresses stored in the destination MAC address table 305.

In decision step 915, the packet reflecting module 203B determines if the destination MAC address is supported by an upstream device 129 (not illustrated), outside of its optical network 200A based on the comparison to the destination MAC address table 305. If the inquiry to decision step 915 is negative, then the “No” branch is followed to decision step 917. If the inquiry to decision step 915 is positive meaning that the packet reflection module 203B knows the destination MAC address is supported outside of its optical network 200A, then the “Yes” branch is followed to step 916 in which the frame 205 is forwarded upstream over the outside optical network to the data service hub 110. After step 916, the process ends.

In decision step 917, the packet reflecting module 203B determines if the destination MAC address is supported by the LTN 120 in its optical network 200A based on the comparison to the destination MAC address table 305 in step 908. If the inquiry to decision step 917 is negative, then the “No” branch is followed to step 918 in which the upstream frame 205 is replicated and sent upstream over the outside optical network to the data service hub 110.

Next, in step 920, the reflecting module 203B, and specifically, the multicast-Port ID flag adjuster 503 of FIG. 5B changes the multi-cast Port ID flag 507 of FIG. 5A to a value of one to indicate that a reflected flag is present. The process then proceeds to step 926.

If the inquiry to decision step 917 is positive meaning that the packet reflecting module 203B has determined a match between the upstream destination MAC address and the destination MAC address table 305B, then the “Yes” branch is followed to step 926. In step 926, the downstream frame 207 is propagated across the optical network 200A to all of the SOIs 140 being serviced by the corresponding LTN 120.

In decision step 937, at each SOI 140, each downstream packet receiving module 405B, and specifically, the multicast-port ID flag reader 569 of FIG. 5C will determine if the value of the multicast-port ID flag 507 of FIG. 5A indicates that the downstream frame 207 is a multicast frame 207 originating from another SOI 140. If the inquiry to decision step 937 is positive, meaning that the downstream frame 207 is reflected, then “Yes” branch is followed to decision step 940. If the inquiry to decision step 937 is negative, then the “No” branch is followed to decision step 943.

In decision step 940, the downstream packet reviewing module 405B determines if any of the SOIs 140 Port-IDs match the SOURCE Port-ID of the downstream multicast frame 207. If the inquiry to decision step 940 is positive meaning that the Port-ID of the SOI 140 does match the source Port-ID of the downstream multicast frame 207, then the “Yes” branch is followed to step 946 in which the downstream multicast frame 207 is dropped or discarded. The process then ends.

If the inquiry to decision step 940 is negative meaning that the Port-ID of the SOI 140 does NOT match the source Port-ID of the downstream multicast frame 207, then the “No” branch is followed to step 949 in which the downstream reflected frame 207 is passed to the one or more devices 129 coupled to the SOI 140. The process then ends.

In decision step 943, the downstream packet reviewing module 405B determines if any of the SOIs 140 Port-IDs match the DESTINATION Port-ID of the downstream NON-multicast (possibly unicast) frame 207. If the inquiry to decision step 943 is positive meaning that the Port-ID of the SOI 140 does match the DESTINATION Port-ID of the downstream NON-multicast frame 207, then the “Yes” branch is followed to decision step 948.

If the inquiry to decision step 943 is negative meaning that the Port-ID of the SOI 140 does NOT match the DESTINATION Port-ID of the downstream NON-multicast frame 207, then the “No” branch is followed to step 946 in which the downstream Non-multicast frame 207 is dropped or discarded. The process then ends.

In decision step 948, it is determined if the destination MAC address matches any devices 129 coupled to the reviewing SOI 140. If the inquiry to decision step 948 is positive, the “Yes” branch is followed to step 949. If the inquiry to decision step 948 is negative, the “No” branch is followed to step 946 in which the frame is dropped or discarded. The process then ends.

If the inquiry to decision step 948 is positive meaning that a device 129 is coupled to the reviewing SOI 140 with a matching destination MAC address, the “Yes” branch is followed to step 949. In step 949, downstream frame 207 is allowed to pass to the device 129 with the matching destination MAC address. Then, in step 951, if a device 129 with a matching destination MAC address exists, it will send an acknowledgement message back upstream to the LTN 120. The process then ends.

### Exemplary Fourth Process Flow Corresponding to System of FIG. 6

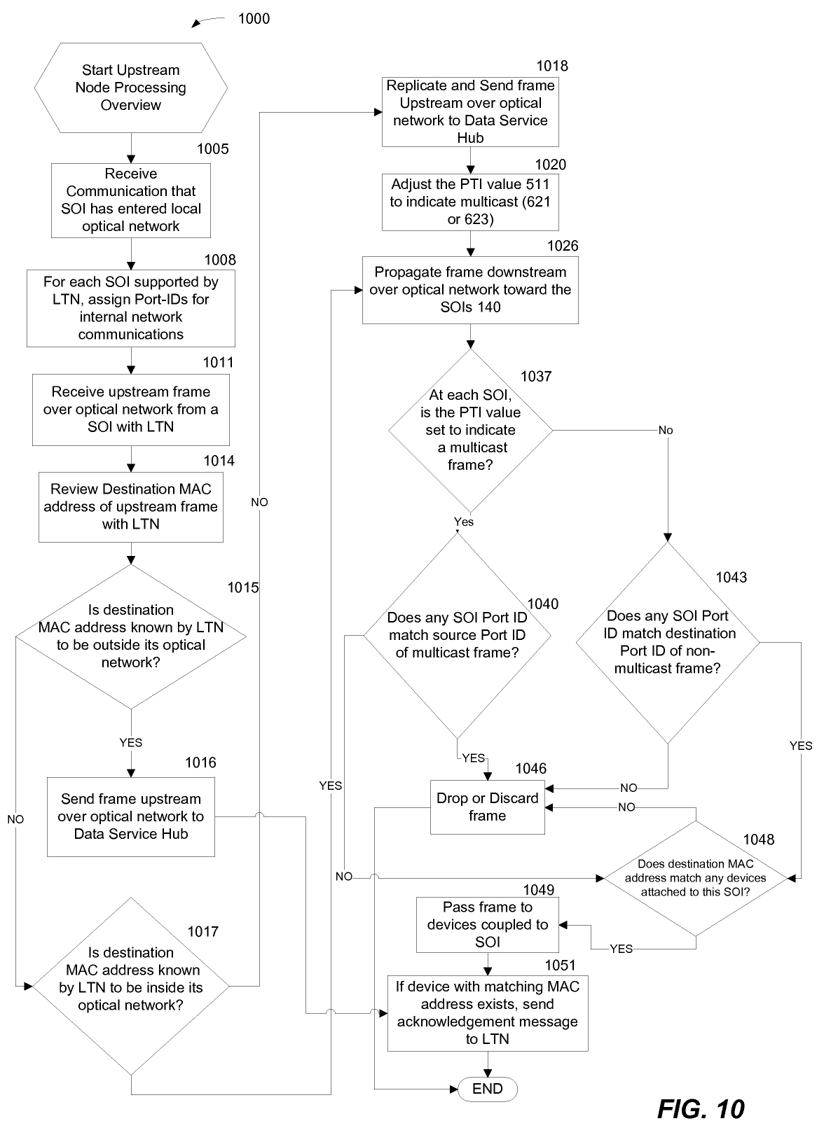

Referring now to FIG. 10, this figure is a logic flow diagram illustrating an exemplary method 1000 for supporting communications between SOIs 140 coupled to the same LTN 120 in an optical network 200A in which the LTN 120 and SOIs 140 can utilize a payload type indicator field to track downstream reflected frames 207 according to one exemplary embodiment of the invention.

Step 1005 is the first step of the method or process 900 in which the packet reflecting module 203C of FIG. 6B receives a communication that an SOI 140 has joined the optical network 200A supported by the LTN 120. Next, in step 1008, for each SOI 140 that is supported by the LTN 120, the packet reflecting module 203C of FIG. 5B assigns unique Port-IDs for internal network communications.

That is, the packet reflecting module 203C of FIG. 6B assigns unique Port-IDs to SOIs 140 that are coupled to the same LTN 120. However, the amount of Port-IDs assigned to SOIs 140 in this embodiment will be significantly less than the amount set forth in FIG. 2. Usually, in this exemplary embodiment, each SOI 140 can be assigned one or two Port-IDs because this exemplary embodiment is relying upon new fields in the optical network protocol in order to determine if a frame 207 has been multicast instead of relying on the value of the Port-ID to determine reflection status.

In step 1011, the packet reflecting module 203C of FIG. 6B receives an upstream frame 205 from an SOI 140. In step 1014, the packet reflecting module 203B reviews the destination MAC address of the upstream frame 205 and compares the MAC address to the list of MAC addresses stored in the destination MAC address table 305C.

In decision step 1015, the packet reflecting module 203B determines if the destination MAC address is supported by an upstream device 129 (not illustrated), outside of its optical network 200A based on the comparison to the destination MAC address table 305C. If the inquiry to decision step 1015 is negative, then the “No” branch is followed to decision step 1017. If the inquiry to decision 1015 step is positive meaning that the packet reflection module 203C knows the destination MAC address is supported outside of its optical network 200A, then the “Yes” branch is followed to step 1016 in which the frame 205 is forwarded upstream over the outside optical network to the data service hub 110. After step 1016, the process ends.

In decision step 1017, the packet reflecting module 203C determines if the destination MAC address is supported by the LTN 120 in its optical network 200A based on the comparison to the destination MAC address table 305. If the inquiry to decision step 1017 is negative, then the “No” branch is followed to step 1018 in which the upstream frame 205 is replicated and sent upstream over the outside optical network to the data service hub 110.

Next, in step 1020, the reflecting module 203C, and specifically, the payload type indicator (PTI) adjuster 605 of FIG. 6B adjusts the value of payload type indicator field 511 to be a value of either 621 or 623 as illustrated in FIG. 6A to indicate that a multicast flag is present. The process then proceeds to step 1026.

If the inquiry to decision step 1017 is positive meaning that the packet reflecting module 203C has determined a match between the upstream destination MAC address and the destination MAC address table 305C, then the “Yes” branch is followed to step 1026. In step 1026, the downstream frame 207 is propagated across the optical network 200A to all of the SOIs 140 being serviced by the corresponding LTN 120.

In decision step 1037, at each SOI 140, each downstream packet receiving module 405C, and specifically, the payload type indicator (PTI) reader 615 of FIG. 6C will determine if the value of the PTI field 511 of FIG. 6 indicates that the downstream frame 207 is a multicast frame 207. If the inquiry to decision step 1037 positive meaning that the downstream frame 207 is multicast, then “Yes” branch is followed to decision step 1040. If the inquiry to decision step 1037 is negative, then the “No” branch is followed to decision step 1043.

In decision step 1040, the downstream packet reviewing module 405C of FIG. 6C determines if any of the SOIs 140 Port-IDs match the SOURCE Port-ID of the downstream multicast frame 207. If the inquiry to decision step 1040 is positive meaning that the Port-ID of the SOI 140 does match the source Port-ID of the multicast frame 207, then the “Yes” branch is followed to step 1046 in which the downstream frame 207 is dropped or discarded. The process then ends.

If the inquiry to decision step 1040 is negative meaning that the Port-ID of the SOI 140 does NOT match the source Port-ID of the multicast frame 207, then the “No” branch is followed to step 1049 in which the downstream multicast frame 207 is passed to the one or more devices 129 coupled to the SOI 140. The process then ends.

In decision step 1043, the downstream packet reviewing module 405C of FIG. 6C determines if any of the SOIs 140 Port-IDs match the DESTINATION Port-ID of the downstream NON-multicast (possibly unicast) frame 207. If the inquiry to decision step 1043 is positive meaning that the Port-ID of the SOI 140 does match the DESTINATION Port-ID of the downstream NON-multicast frame 207, then the “Yes” branch is followed to step 1048.

If the inquiry to decision step 1043 is negative meaning that the Port-ID of the SOI 140 does NOT match the DESTINATION Port-ID of the downstream NON-multicast frame 207, then the “No” branch is followed to step 1046 in which the downstream Non-multicast frame 207 is dropped or discarded. The process then ends.

In decision step 1048, it is determined if the destination MAC address matches any devices 129 coupled to the reviewing SOI 140. If the inquiry to decision step 1048 is positive, the “Yes” branch is followed to step 1049. If the inquiry to decision step 1048 is negative, the “No” branch is followed to step 1046 in which the packet is dropped or discarded. The process then ends.

If the inquiry to decision step 1048 is positive meaning that a device 129 is coupled to the reviewing SOI 140 with a matching destination MAC address, the “Yes” branch is followed to step 1049. In step 1049, downstream frame 207 is allowed to pass to the device 129 with the matching destination MAC address. Then, in step 1051, if a device 129 with a matching destination MAC address exists, it will send an acknowledgement message back upstream to the LTN 120. The process then ends.

### CONCLUSION

A backwards compatible method and system for receiving upstream packets and reflecting the packets downstream to support communications between subscriber optical interfaces (SOIs) coupled to a same laser transceiver node (LTN) is provided by the invention. Backwards compatible means that the method or system is compatible with legacy subscriber optical interfaces that do not need any new or modified hardware or physical equipment. The backwards compatible method assigns each legacy SOI a set of Port-IDs to support communications with SOIs on the same optical network. In addition to a backwards compatible method and system, a non-backwards compatible system or method that are not compatible with legacy subscriber optical interfaces 140 is provided. According to this method and system, each LTN and SOI has new hardware or software (or both) to support new fields of an optical network protocol that indicate multicast downstream packets.

What is claimed is:

1. A backwards compatible method for receiving upstream frames and reflecting the frames downstream to support communications between subscriber optical interfaces (SOIs) coupled to a same laser transceiver node, the method comprising:
receiving an upstream frame from a subscriber optical interface with a laser transceiver node;
determining if the frame is destined for one of a subscriber optical interface and a device coupled to a subscriber optical interface serviced by the laser transceiver node;
modifying a field within the frame to indicate a multicast communication;
sending the modified frame downstream to each subscriber optical interface coupled to the laser transceiver node, wherein the method is compatible with legacy subscriber optical interfaces.

2. The method of claim 1, further comprising at each subscriber optical interface, reviewing the downstream frame and determining if the downstream frame is acceptable for a subscriber optical interface.

3. The method of claim 2, wherein determining what subscriber optical interface originated the upstream frame further comprises determining if a Port-ID assigned to a reviewing subscriber optical interface is identical to a Port-ID of the downstream frame.

4. The method of claim 1, further comprising receiving a communication that a subscriber optical interface has been coupled to the laser transceiver node, and assigning unique port-IDs to the subscriber optical interface.

5. The method of claim 2, wherein determining if the downstream frame is acceptable for a subscriber optical interface further comprises performing a calculation on the Port-ID field of the upstream frame to determine if a reviewing subscriber optical interface is identical to an originating subscriber optical interface.

6. The method of claim 6, wherein the calculation comprises subtracting a value from Port-ID field.

7. A method for receiving upstream frames and reflecting the frames downstream to support communications between subscriber optical interfaces (SOIs) coupled to a same laser transceiver node, the method comprising:
receiving an upstream frame with a laser transceiver node from a subscriber optical interface;
determining if the frame is destined for one of a subscriber optical interface and a device coupled to a subscriber optical interface serviced by the laser transceiver node;
modifying a multicasting-port ID field within the frame to indicate a multicast communication;
sending the modified frame downstream to each SOI coupled to the laser transceiver node wherein each support legacy subscriber optical interface has one of software and hardware to process the multicasting-port ID field.

8. The method of claim 7, further comprising determining if any Port-ID of a reviewing subscriber optical interface matches a Port-ID of a multicast frame.

9. The method of claim 8, wherein if any Port-ID of a reviewing subscriber optical interface matches a Port-ID of a multicast frame, then dropping the multicast frame.

10. The method of claim 8, wherein if any Port-ID of a reviewing subscriber optical interface does not match a Port-ID of a multicast frame, then determining if a MAC address of the multicast frame matches a MAC address of a device coupled to a reviewing subscriber optical interface.

11. The method of claim 7, further comprising reviewing the multicast-Port ID field to determine if the downstream frame is a multicast frame.

12. A method for receiving upstream frames and reflecting the frames downstream to support communications between subscriber optical interfaces (SOIs) coupled to a same laser transceiver node, the method comprising:
receiving an upstream frame with a laser transceiver node from a subscriber optical interface;
determining if the frame is destined for one of a subscriber optical interface and a device coupled to a subscriber optical interface serviced by the laser transceiver node;
modifying a payload type indicator field within the frame to indicate a multicast communication;
sending the modified frame downstream to each SOI coupled to the laser transceiver node, wherein each support legacy subscriber optical interface has one of software and hardware to process the payload type indicator field.

13. The method of claim 12, further comprising reviewing the payload type indicator field to determine if the downstream frame is a multicast frame.

14. The method of claim 12, further comprising determining if any Port-ID of a reviewing subscriber optical interface matches a Port-ID of a multicast frame.

15. The method of claim 14, wherein if any Port-ID of a reviewing subscriber optical interface matches a Port-ID of a multicast frame, then dropping the multicast frame.

16. The method of claim 14, wherein if any Port-ID of a reviewing subscriber optical interface does not match a Port-ID of a multicast frame, then determining if a MAC address of the multicast frame matches a MAC address of a device coupled to a reviewing subscriber optical interface.
